(19) United States
(12) Patent Application Publication
(10) Pub. No.: US 2011/0239642 A1
(43) Pub. Date: Oct. 6, 2011

(54) Double-Acting, Two-Stroke HCCI Compound Free-Piston Rotating-Shaft Engine

(76) Inventors: Paul A. Schwiesow, Arvada, CO (US); Ronald L. Schwiesow, Boulder, CO (US); Dino Tomassetti, JR., Belle Harbor, NY (US)

(21) Appl. No.: 12/939,149

(22) Filed: Nov. 3, 2010

(51) Int. Cl. F02B 71/06

(52) U.S. Cl. 60/595

(57) ABSTRACT

This invention provides a compact, fuel-efficient internal combustion engine that can be used to provide rotating shaft output power to a wide variety of mobile and stationary applications. It is based on a two-stroke free-piston gas generator that implements the homogeneous charge compression ignition (HCCI) combustion principle for essentially constant-volume combustion, and it employs a variable piston stroke to maintain a high level of efficiency across a wide range of loads and speeds. A rotary device, which may be of either an aerodynamic or positive displacement type, converts the energetic gas stream to power at a rotating shaft.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

This invention pertains to thermodynamically efficient internal combustion engines, particularly U.S. Patent Classifications 123/46R (free piston engines), 123/46A (free piston engines with two chambers and one piston), 123/46B (free piston engines-phasing means between two or more units) and 60/595 (power plants in which a free piston device supplies motive fluid to a motor). In addition to the field of free-piston engines, the invention is relevant to internal combustion engines employing homogeneous charge compression ignition (HCCI). It is also relevant to the efficient operation of internal combustion gas turbine engines. In one embodiment employing compressed air starting, the invention pertains to U.S. Patent Classification 60/596 (power plants using a free piston device with a pressure fluid starting means).

Compound free-piston rotating-shaft engines are known and have been proposed as a means of improving fuel efficiency, reducing cost, and adding multifuel capability to conventional gas turbine engines. Such compound engines have also been proposed as a means of improving fuel efficiency, increasing power density, improving low-speed torque, reducing cost and complexity, and adding multifuel capability to conventional crank-piston internal combustion engines. Most early designs employed a free-piston unit of the “two-piston opposed” type to generate pressurized gas, and used the pressurized gas to rotate an axial power turbine, as instanced by U.S. Pat. No. 2,101,412 and A. F. Underwood, “The GMR 4-4 ‘Hyprex’ Engine: A Concept of the Free-Piston Engine for Automotive Use,” SAE Transactions 65 (1957): 377-391. Known prototypes demonstrated an ability to run on a wide variety of liquid fuels, had very low vibration, and exhibited excellent low-speed torque. However, they proved to have fundamental structural weaknesses and were very bulky and heavy. Fuel efficiency was reported to be roughly equal to or slightly better than that of conventional crank piston engines.

A proposed improvement to the “two-piston opposed” model for the compound free-piston rotating-shaft engine is the “double-acting” model instanced by U.S. Pat. No. 1,785,643, U.S. Pat. No. 2,963,008, and U.S. Pat. No. 4,205,528. These and similar designs incorporate a free-piston gas generator unit in which a single, double-ended piston, or alternatively a single assembly consisting of two pistons fixedly attached to each other via a rigid connecting rod, oscillates back and forth in a single cylinder, with combustion occurring at alternate cylinder ends. The pressurized gas thus produced is used to rotate a power turbine to do useful work, while the piston motion itself is used solely to produce compression in the cylinder end opposite each combustion event. Such designs claim greatly increased operating frequency of the free-piston unit, as well as superior structural strength, greater simplicity, and dramatically reduced weight and size, relative to the “two-piston opposed” model.

Within the past twenty years, free piston engines of the double-acting type have been proposed as a means of obtaining homogeneous charge compression ignition (HCCI), which offers advantages over conventional combustion models in terms of near-instantaneous burn rate (hence nearly ideal constant volume combustion), the enabling of high compression ratios, the ability to run unthrottled at very lean mixtures, multifuel capability, and reduced particulate and NOₓ emissions. Free-piston engines, and more particularly double-acting free-piston engines, are a natural fit for HCCI combustion: because such engines have inherently variable stroke, a compressing force may be applied indefinitely to a homogeneous charge of any temperature and equivalence ratio until the charge spontaneously ignites, and, because piston motion is unconstrained, the exact moment of combustion need not be controlled. This is in marked contrast to existing crank-piston HCCI engines, in which engine temperature, temperature of the intake charge, and equivalence ratio must be carefully monitored and controlled to ensure that spontaneous ignition occurs at or near top dead center of piston motion. Crank-piston HCCI engines additionally face the potential for rods and cranks to be damaged by the high pressure peaks characteristic of HCCI combustion: because of this, they are typically run at very lean mixtures and constant low loads. Free piston engines, by contrast, have no conventional rods or cranks, and can thus theoretically be operated across a wide power range at mixtures up to and including the stoichiometric ratio without damage to engine components.

While several recent designs utilize HCCI combustion in a double-acting, two stroke free-piston engine (e.g., U.S. Pat. No. 6,199,519 and U.S. Pat. No. 6,700,229), none employs the engine as a gas generator in a compound free-piston rotating-shaft configuration. The first example above is configured as an electrical linear alternator, for instance, while the second assumes a configuration as either a linear alternator or a hydraulic or pneumatic pump. All other known configurations of double-acting, two-stroke, HCCI free-piston engines of the prior art incorporate one of these three power extraction methods. These configurations fail to take full advantage of the double-acting free piston model for HCCI operation: because they attempt to extract useful work from the piston motion, piston speed and momentum are reduced, and the engine's ability to generate a compressing force sufficient for spontaneous combustion of the charge is thereby rendered problematic. In practice, most such engines require complex sensing and control mechanisms to balance compression force with power extraction forces, and they have thus been confined to constant-load operation. Also, because extracting work from piston motion reduces the maximum attainable operating frequency of the engine, such engines have exhibited poor power density. A superior solution is suggested by utilizing a power turbine or rotary air motor for power extraction in two-stroke free-piston HCCI engines of this type, but there is no known instance of such a design in the prior art.

The prior art does contain at least one instance of a double-acting, two-stroke HCCI free-piston gas generator in isolation, namely that described by J. Horton (“Amazing New Lightweight Turbine,” Mechanix Illustrated [February, 1969]: 66-68; 134-136). Because it is configured as a pure jet with no attempt made to extract work from the piston motion, the Horton engine enjoys several advantages over a similar engine configured as a linear alternator or hydraulic or pneumatic pump, including simplicity (no sensing or control mechanisms are required, and the engine has three moving parts), extremely high operating frequency, and very light weight. However, since the Horton engine is a pure jet, it has a limited range of applications (for instance, it is unsuitable for a land vehicle operated in traffic). Additionally, the Horton engine is reported to suffer from extreme noise, as well as from typical two-stroke disadvantages of needing to add lubricant to the fuel and of short-circuiting raw fuel out the exhaust. Finally, the Horton engine employs an engine geometry that requires very precise machining and that is nonetheless vulnerable to leakage and binding. All of these challenges are addressed by the present invention.

Special mention should be made of two additional patents: U.S. Pat. No. 1,785,643 (referenced earlier) and U.S. Pat. No. 7,258,086. U.S. Pat. No. 1,785,643 (Noack et al.) describes a double-acting, two-stroke compound free piston-gas turbine engine in which an integral, reciprocating linear electric motor/generator is coupled to a rotary generator in order to synchronize piston motion in multiple free-piston units. While the Noack engine did not utilize HCCI combustion, the use of a linear motor/generator to synchronize piston motion is similar to that put forward in an alternative embodiment of the present invention, which will be described later in greater detail. U.S. Pat. No. 7,258,086 (Fitzgerald) describes a four-cylinder, four-stroke, HCCI, compound free piston-gas turbine engine as one alternative embodiment. While this stated embodiment shares several operating principles with the current invention, numerous distinctions arise from the unique architecture required to support four-stroke vs. two-stroke operation. Relative to the compound free piston-gas turbine embodiment claimed in U.S. Pat. No. 7,258,086, the present invention: 1) uses half the number of pistons and cylinders to obtain the same number of power strokes; 2) eliminates a moving piston linkage; 3) utilizes simple ports rather than a positive valving system; 4) employs an under-piston chamber to provide scavenging pressure rather than employing a separate intake stroke; 5) employs closed-cylinder fuel injection in preference to open; 6) employs a novel, closed-circuit lubrication system, and 7) provides for the optional substitution of a positive-displacement air motor and/or centrifugal turbine in place of the “power turbine” named in the Fitzgerald embodiment. A four-stroke architecture is one valid means of addressing common two-stroke problems of a narrow power band, poor fuel efficiency, and high emissions; however, the current invention utilizes alternative means to address these problems and eschews a four-stroke architecture in favor of the higher operating frequency, improved power density, decreased complexity and cost, and reduced friction inherent in its two-stroke configuration.

### BRIEF SUMMARY OF THE INVENTION

The present invention is based on the type of two-stroke, “double-acting” compound free-piston rotating-shaft engine design described in the prior art. That is, it consists of at least a free-piston device to compress, combust, and partially expand a charge, and a rotary device that uses the pressurized gas thereby obtained to turn an output power shaft. In contrast to the prior art regarding such compound engines, the present invention employs homogeneous charge compression ignition (HCCI) as the combustion model: this is done to take advantage of the superiority of HCCI over other combustion models in terms of thermodynamic efficiency, multifuel capability, and reduced emissions. The currently preferred embodiment includes a rotary supercharger or turbocharger to provide initial compression of input air to the free-piston engine; an additional embodiment allows for the substitution of a positive-displacement air motor and/or centrifugal turbine in place of the axial- or impulse-type power turbines of the prior art. In order to start the engine, regularize piston motion, and synchronize piston motion in the event that multiple free-piston components are used, an integral linear electric motor/alternator is provided for under the claims. The claims also provide for an alternative embodiment in which compressed air means and a conventional ignition system are employed for initial engine start.

One way of looking at the configuration of the present invention is to consider it similar to a conventional gas turbine engine (turboshaft) in which the higher-pressure stages of the compressor, the combustor can(s), and the first stages of the compressor turbine have been replaced by the free-piston unit. By using the positive-displacement device of free pistons to quickly and efficiently attain compression rather than using the inefficient dynamic device of multiple rotating compressor stages, and by employing intermittent, closed, near-ideal constant-volume combustion in preference to continuous, open-ended, constant-pressure combustion, the present invention operates at a much higher thermodynamic efficiency than a conventional gas turbine engine.

An alternative way of looking at the present invention is to consider it similar to a supercharged or turbocharged two-stroke crank-piston engine with the crank and connecting rods removed. This allows for easy accommodation of HCCI combustion, which is more thermodynamically efficient than either compression-ignition direct-inject (“diesel”) or homogeneous-charge spark-ignition (“petrol”) combustion modes. Freeing the pistons to operate with the sole constraints of fluid and inertial forces places the structure of the engine under much less stress than crank-piston configurations; it also decouples the frequency of combustion from the rotational speed of the output shaft, allowing for higher operating frequencies, improved power density, rapid delivery of full power from idle, and the development of extremely high torque at low shaft output speeds.

### Operation

The operation of the free-piston gas generator portion of the invention greatly reduces the complications of the prior art. It has one primary moving part: a single assembly consisting of two pistons fixedly attached to each other via a rigid connecting rod, oscillating in a single cylindrical “case” closed at each end and divided into two functionally separate cylinders by a central, axially fixed, disk-shaped divider element. The only other moving parts are two passive reed valves controlling the intake air flow and two in-cylinder fuel injectors. (Both of these last elements are optional, but are utilized by the currently preferred embodiment.) Simple intake ports, upper and lower transfer ports, and exhaust ports are introduced into the cylinder walls.

Combustion occurs in an alternating fashion at either cylinder end, between the top of each piston head and its respective cylinder head. For purposes of illustration, the sequence of events is described beginning with the piston/connecting rod assembly closest to the cylinder head on one side of the device: for instance, the left side. In this position, the charge in the left-side combustion chamber has been compressed to the point of autoignition. Once it ignites, the piston/connecting rod assembly begins its expansion stroke toward the right. On the right side, fresh intake air is drawn past the right-side intake port and reed valve into the chamber formed between the underside of the right-side piston and the central, axially fixed divider element. Meanwhile, in the right-side combustion chamber formed between the piston head and cylinder head once the piston head has closed the exhaust port, the intake air from the previous stroke is compressed and fuel is injected. At the same time, the fresh intake air pulled into the left-side under-piston chamber on the previous stroke is compressed by the motion of the piston toward the central divider element. Once the left-side piston head has passed the left-side exhaust port, the expanding combustion products from the left-side combustion chamber are evacuated through the exhaust port toward the power turbine (or positive-displacement air motor, in an alternative embodiment). When evacuation is complete, the pressurized fresh air from the left-side under-piston chamber is admitted through transfer ports into the left side combustion chamber, scavenging any remaining combustion products. The piston/connecting rod assembly then reaches its farthest extent on the right side, the right-side charge autoignites, and the cycle begins again. The operation is similar to that of a standard twin-cylinder, twin-piston engine using a two-stroke cycle, except that there is no crank, no conventional crankcase, no conventional rods connecting the pistons to the crank, and no conventional spark-ignition system.

### Advantages

Several advantages of the present invention over conventional gas turbine engines, conventional crank-piston engines, crank-piston HCCI engines, compound free piston-rotating shaft engines of the prior art, and free-piston HCCI engines configured as electrical linear alternators or hydraulic or pneumatic pumps have already been enumerated in the previous section. Further advantages over these and additional engine types are detailed below.

In comparison to a conventional gas turbine engine: 1) The present invention is able to reduce manufacturing costs, since an easily machined free-piston unit and conventional supercharger or turbocharger replace multiple, high-precision compressor and compressor turbine stages. 2) The present invention can be idled at much lower fuel consumption, since the variable stroke of the free-piston component enables it to attain maximum compression at idle. 3) The present invention operates with relatively low temperatures at the inlet nozzles of the precompressor turbine and power turbine (or air motor), since peak combustion temperatures are attained at the top of the piston stroke and are greatly reduced by the time the working fluid is expanded at the end of the piston stroke and directed toward the precompressor turbine and power turbine/air motor. This feature enables noncritical materials to be used in the manufacture of precompressor turbine and power turbine/air motor, further decreasing manufacturing costs (see Underwood, p. 379).

In comparison to two- and four-stroke compression-ignition direct-inject (“diesel”) crank-piston engines and two- and four-stroke spark-ignition (“petrol”) crank-piston engines: 1) Thermodynamic efficiency is improved though the utilization of the Pescara thermodynamic cycle, which eliminates the energy losses inherent in Otto and Diesel cycles and approximates a Miller or Atkinson cycle in terms of allowing the effective expansion stroke to be longer than the compression stroke. 2) The rapid burn rate and high piston speed of the present invention improve thermodynamic efficiency by reducing the time available for the heat of combustion to transfer to cylinder walls. 3) Engine efficiency is improved via the elimination of side loads, decreased reciprocating masses, and reduced incidences of sliding friction from conventional connecting rods, crank bearings, cams, and camshafts. 4) Both weight and cost are reduced via the elimination of crankshaft, conventional connecting rods, flywheel, valves, and camshaft. 5) The reduced duration of high combustion temperatures and the reduced peak temperatures of HCCI combustion at low loads and equivalence ratios results in the drastic reduction of NOₓ emissions. At the same time, particulate emissions are reduced as a result of the high fuel atomization and complete burning inherent in HCCI combustion. (See U.S. Pat. No. 6,199,519, FIGS. 8; 11-16; also Energy Efficiency and Renewable Energy, Office of Transportation Technologies, “Homogeneous Charge Compression Ignition [HCCI] Technology: A Report to the U.S. Congress, April 2001” [U.S. Department of Energy, Washington, D.C., 2001], pp. 1-5.) 6) The very high compression ratios attainable in the present invention facilitate uniformly high temperatures of the compressed charge and thus enable the utilization of a wide range of fuel types, including high-viscosity/low-volatility fuels such as Bunker C, Jet-A, kerosene, diesel oil, vegetable oil, and certain types of unrefined crude oil (See Underwood, p. 378). It is anticipated that the present invention should also operate satisfactorily on gaseous fuels such as butane, CNG, LPG, and pure and impure hydrogen, as well as renewable fuels such as biodiesel, pure ethanol, and pure methanol, without engine modification (see U.S. Pat. No. 6,199,519). Finally, it is anticipated that gasoline and other hydrocarbon fuels of poor quality and/or very low octane and cetane ratings may be utilized, as knock inhibition is not required.

Relative to spark-ignited crank-piston engines specifically: 1) Thermodynamic efficiency is improved though the facilitation of higher compression ratios, since knock, or detonation, is not a limiting factor to compression. In fact, detonation is utilized by the present invention and all HCCI engines as the normal operating mode. 2) The present invention is capable of running at equivalence ratios well below what is possible in conventional spark-ignited engines. This ability to run at lean mixtures leads to better thermodynamic efficiency and allows the engine to be run unthrottled, greatly reducing pumping losses. 3) Since lean mixtures require higher initial temperatures to spontaneously ignite than do richer mixtures, still higher compression ratios are facilitated during lean running. 4) Finally, variable stroke ensures a consistently high effective compression ratio over all load and speed requirements: the engine increases and decreases its working displacement automatically as load and speed dictate. This is a crucial advantage where a wide range of loads and speeds is anticipated, as in an automobile or other mobile application.

Relative to two-stroke spark-ignited crank-piston (“petrol”) engines specifically: 1) The currently preferred embodiment of the present invention utilizes non-critically-timed low-pressure fuel injection into the cylinder after the exhaust port closes, preventing loss of fuel through the exhaust port. 2) The preferred embodiment utilizes a closed-circuit lubrication system in which lubricant is introduced through the hollow connecting rod and does not directly enter the under-piston chamber or mix with the fuel. This reduces undesirable emissions by reducing the amount of lubricant that is burned during combustion. (For the currently preferred embodiment, standard multiweight motor oil is contemplated as a lubricant. Additional lubricant options may include vegetable oils and solid or semi-solid lubricants, as well as unconventional lubricants such as water or gaseous elements, as is possible under the scope of the claims. For examples, see U.S. Pat. No. 4,681,326.)

Finally, relative to four-stroke rotary (Wankel) engines, the present invention offers improved compression ratios, particularly at low loads. It has reduced incidences of sliding friction, as well as improved sealing, a faster burn rate, and an ability to run at low equivalence ratios, which the spark-ignited Wankel engine cannot accommodate.

### BRIEF DESCRIPTION OF THE SEVERAL VIEWS OF THE DRAWING

FIG. 1 is a schematic diagram of the overall compound engine of the invention showing an optional, rotary precompressor driven by a shaft from the power turbine/air motor. In this embodiment, the precompressor functions much like a conventional belt- or gear-driven supercharger, and may utilize positive-displacement or centrifugal compressor means depending on engine application.

FIG. 2 shows an alternative embodiment in which an independent precompressor turbine or air motor is driven by the expanding gases from the free-piston unit after they have passed through the power turbine/air motor. In this embodiment, the precompressor functions much like a conventional turbocharger.

FIG. 3 shows an alternative embodiment similar to FIG. 2, but in this instance the optional precompressor turbine or air motor (turbocharger) is driven from a portion of the pressurized gas from the free-piston gas generator that is diverted from the main flow before it reaches the power turbine/air motor.

FIG. 4 is a view of the free-piston gas generator portion of the compound engine (component 3 in the earlier figures) from the exhaust (gas output) side of the gas generator.

FIG. 5 is similar to FIG. 4, except the view is of the intake side of the gas generator.

FIG. 6 is an end view of the free-piston gas generator showing the section cut for the major internal view.

FIG. 7 is a transverse section of the gas generator showing the intake valve, blow-off valve, and lower transfer ports.

FIG. 8 is a longitudinal section of the gas generator revealing the internal geometry and major aspects of the invention, including the piston-connecting rod assembly, floating divider element, transfer passages, and fuel injectors.

FIG. 9 shows the same longitudinal section of the gas generator shown in FIG. 8, but adds an optional compressed-air and conventional spark ignition system for starting.

FIG. 10 presents a simplified view of the longitudinal section of the gas generator shown in FIG. 8, but presents an alternative embodiment that incorporates an optional, integral linear electric motor/generator for starting and possible synchronization of multiple free-piston gas generator units.

### DETAILED DESCRIPTION OF THE INVENTION

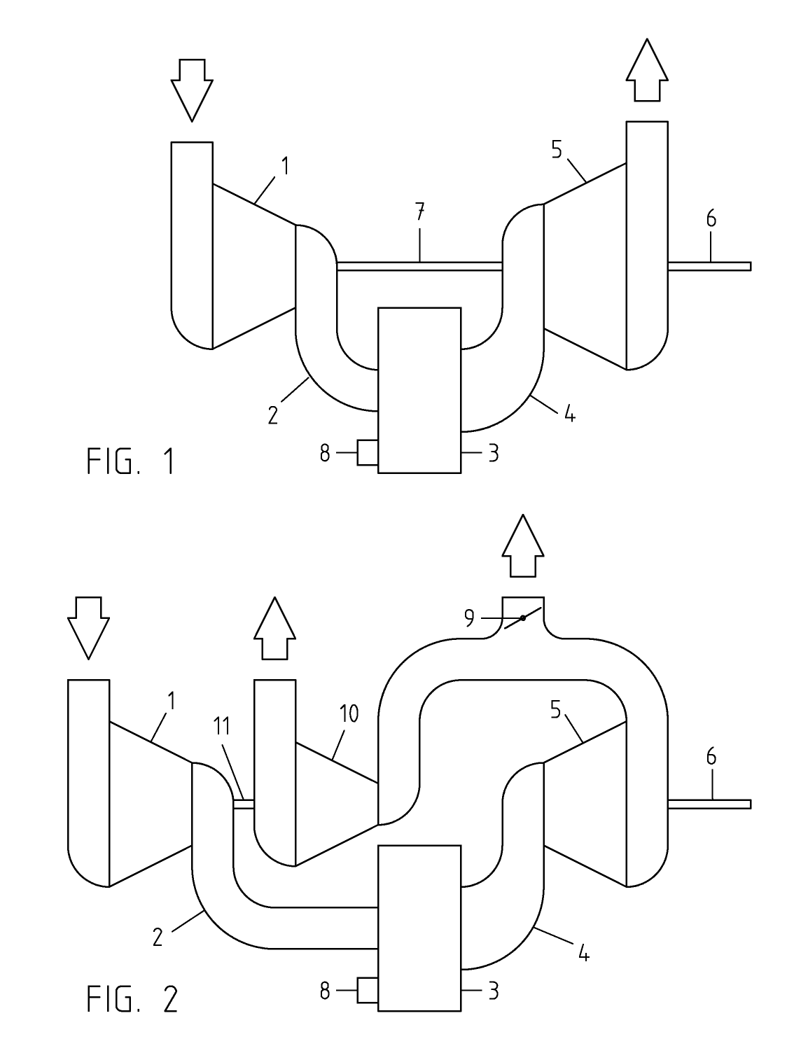

FIG. 1 shows one possible arrangement that might be compared to a supercharged piston engine where the crank and connecting-rod assembly has been replaced by an aerodynamic power turbine or positive-displacement air motor. Intake air (represented by the downward-pointing arrow) may be compressed in precompressor element 1, which may be an aerodynamic or positive-displacement unit, depending on the application. Precompressor 1, if used, is a high-volume, low-pressure device compared to the oscillating piston in the free-piston component of the engine, which may have a compression ratio of much greater than 20:1, depending on operating conditions. Intake duct work 2 conducts the pre-compressed air to the intake ports of the free-piston gas generator 3. The high-temperature, high-pressure gas from gas generator 3 is conducted by exhaust duct work 4 to rotary device 5, which may be an axial or centrifugal turbine, an impulse turbine, or a positive-displacement air motor that may use vane or lobe-type technology. The useful work from the compound engine appears on rotating shaft 6, which substitutes for the crankshaft in a conventional piston engine. Exhaust gas from the overall engine is represented by the upward-pointing arrow. Auxiliary shaft 7 drives precompressor 1 in a fashion similar to a conventional belt- or gear-driven supercharger. Blow-off valve 8 releases pressure in the gas generator in case of an overpressure condition on the intake side of the gas generator that could damage precompressor 1 or otherwise compromise safety.

FIG. 2 shows another possible arrangement that is similar in function to the arrangement of FIG. 1, but that might be conceived of as a conventional gas turbine engine (turboshaft) that has a free-piston gas generator element for higher thermodynamic efficiency. As before, intake air is compressed in precompressor 1 and fed through duct work 2 to the crankless, free-piston gas generator 3. The high-temperature, high-pressure output gas from the free-piston gas generator 3 is conducted by duct work 4 to the power turbine/air motor 5. The power output is on shaft 6. After passing through power turbine/air motor 5, the output gas is conducted through ductwork to auxiliary air motor 10, and the energy remaining in the gas is utilized to drive precompressor 1 through short shaft 11, much as a conventional turbocharger is driven by engine exhaust. Waste gate 9 allows excess gas to be bled off to the atmosphere to prevent excessive rotational speed of auxiliary air motor 10 and precompressor 1. As in the arrangement in FIG. 1, blow-off valve 8 provides safety from an overpressure condition.

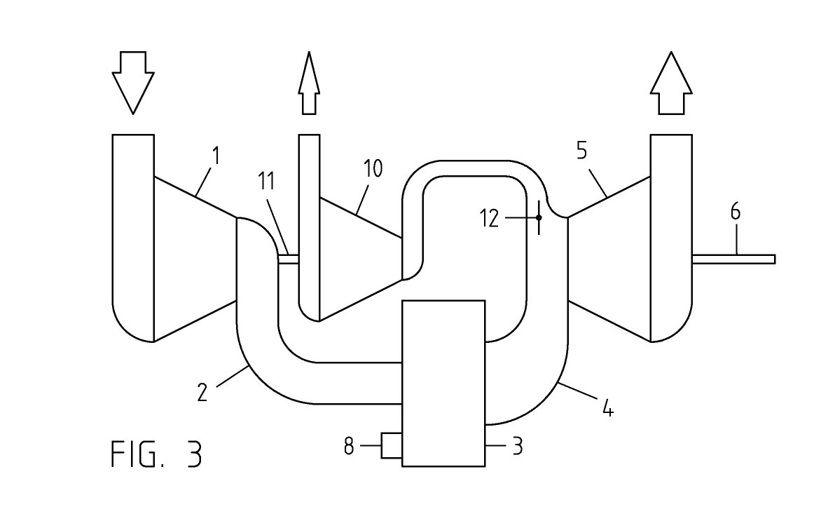

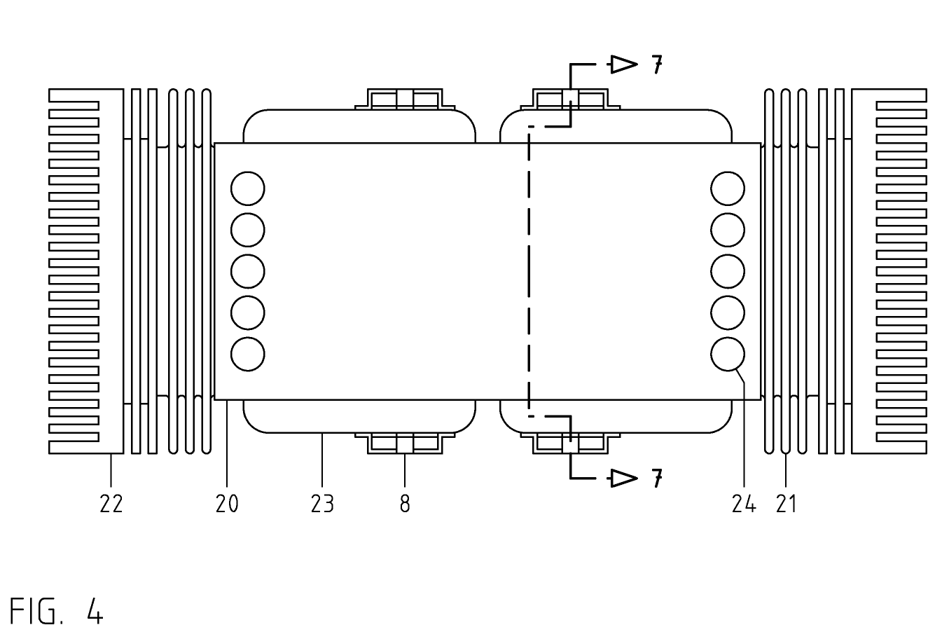

FIG. 3 presents an alternative embodiment similar to FIG. 2, but in this case a smaller volume of higher-energy gas from a branch of exhaust duct 4 is drawn off prior to entering power turbine/air motor 5, and used to drive auxiliary air motor 10. Diverter valve 12 regulates the amount of energetic gas delivered to auxiliary air motor 10 in much the same way as a conventional waste gate on a turbocharger, but without wasting any of the output from gas generator 3.

FIG. 4 begins the focus on the free-piston gas generator itself, which contains many of the innovative elements of the present invention in comparison with previous art. This view is toward the exhaust side of the gas generator. (This and following figures show a currently preferred embodiment, including air cooling for example, but many variations are possible under the scope of the claims.) Note the mirror symmetry in this embodiment, which allows one reference number to refer to a number of elements. In this view, the free-piston component of the engine exhibits mirror symmetry about a horizontal plane through the axis and about a plane perpendicular to the axis.

In FIG. 4, main case 20 serves as the foundation for the gas generator. It may have a square cross section for ease of manufacture and attachment of duct work and auxiliary parts. Cylinders 21 are inserted in the case to provide a precision bore for the free-piston assembly. Cylinder heads 22 on both ends of the gas generator form the combustion chambers. Heads are very simple and require no valves, ports, or other complications. Transfer passages 23 are part of the charging and scavenging system for combustion and will be shown in other ways in following views. Blow-off valves 8 are mounted on the transfer passages 23 and are shown in more detail later. Exhaust ports 24 are opened and closed by the piston assembly, as will become clearer in following views. The exhaust ports are comprised of a plurality of holes and interspaced webbing in order to avoid catching piston rings. Broken line 7-7 shows the plane of a sectional view which will be shown in FIG. 7. The section plane is staggered axially to show details of the transfer passages 23, the blow-off valves 8, and the lower transfer ports.

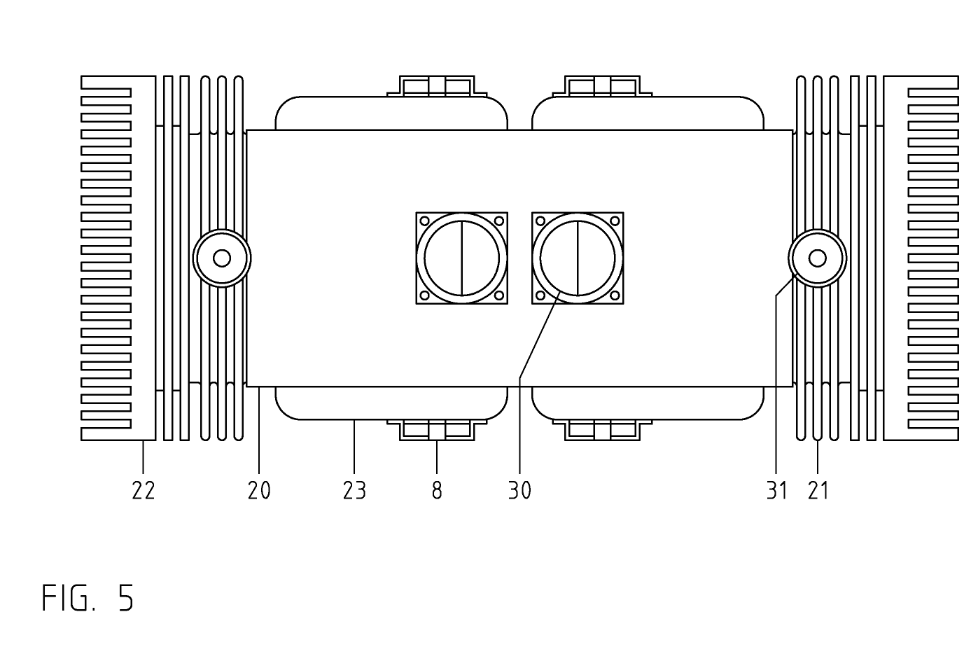

FIG. 5 is similar to FIG. 4 except that the view is toward the intake side of the gas generator, a 180-degree rotation of the unit from the previous view. As before, case 20 supports cylinders 21, which are capped by heads 22. Transfer passages 23 are again in position on case 20 and include blow-off valves 8 as part of each assembly. Intake ports and reed valve assemblies 30, which will appear in other views, feed the intake air into the case below the pistons (i.e., toward the center of the case). Fuel injectors 31 are mounted on flats machined into the side of the cylinders 21. Although in-cylinder injectors are used in the currently preferred embodiment to reduce fuel lost through the exhaust ports, the claims also provide for the use of carburetors or throttle-body injectors upstream of the intake ports and for intake ports controlled by the piston skirts or by self-actuating poppet valves rather than by reed valves, for example. Placement of the in-cylinder injectors in the cylinder heads rather than the side of the cylinders is also possible under the scope of the claims.

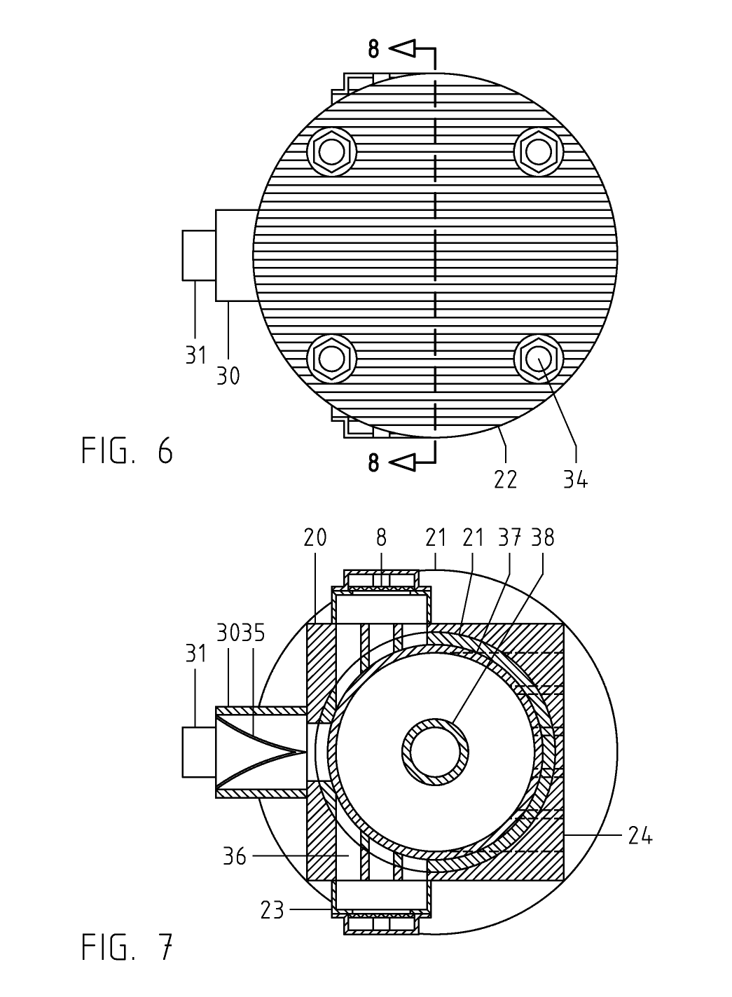

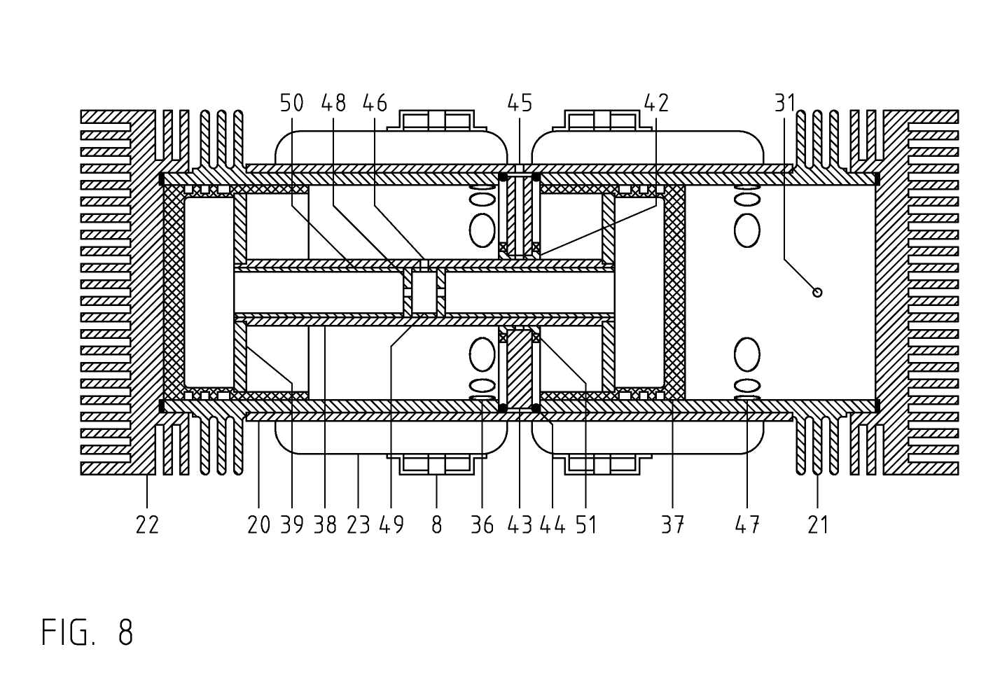

FIG. 6 is a view looking along the axis of the cylinder at one end of the gas generator unit. The view is dominated by the cylinder head 22. Intake port and valve housings 30 project beyond head 22 on the intake side of the unit, as do fuel injectors 31. Head-attachment studs 34 are anchored in the corners of the case and hold the gas generator together. Broken line 8-8 shows the plane of a sectional view which will be shown in FIG. 8.

FIG. 7 is the sectional view along the axis of the gas generator taken looking near the center of the unit toward the cylinder head, as indicated in the section lines on FIG. 4. The square cross section of the foundational case 20 is clearly seen in this view. Cylinder 21 is seen in section as a sleeve insert in the case and is seen looking at the underside of the lowest cooling fin, which is also referenced as 21 in this view. The transfer passages 23 are shown in section on the upper and lower faces of the case 20. Blow-off valves 8 are shown in section attached to the transfer passages 23. The blow-off valves are light, gasketed disks, shown cross-hatched, covering large holes in the transfer-passage housing 23. A four-leg frame above the valve disks centers the disks on the hole and captures a coil spring (not shown) sealing the disks against the transfer passages. In the event that excess pressure develops below the piston, gases will pass through the lower transfer ports (see next paragraph) into the transfer passages 23 and out blow-off valves 8.

In FIG. 7, intake port and valve housing 30 is seen in section; note the port as a drilled passage (no hatching) through the side of both case 20 and cylinder 21. Fuel injector 31 is again largely hidden behind the intake housing 30. Optional intake reed valves 35 are schematically indicated in the intake-port housing. There are six lower transfer ports 36 cut by the section plane in this half of the gas generator. They are drilled perpendicular to the upper and lower faces of case 20. As in the case of the exhaust ports, a plurality of drilled holes comprising the port allow for webs between holes to avoid catching piston rings. The section plane cuts also the piston 37 at the skirt level and the connecting rod 38, which is tubular. The region between the piston 37 and the connecting rod 38 is the underside of the mounting plate that connects the rod to the piston, identified as mounting plate 39 in the next view. Exhaust ports 24 are seen in this view as hidden lines, which show the plurality of exhaust ports and their angular relationship to both intake and lower transfer ports.

FIG. 8 reveals the inner structure that is at the heart of the free-piston portion of the invention. Case 20 again serves as the foundation to connect and align the cylinders 21. Cylinder heads 22 are seen to overlap the upper ends of the cylinders 21 and constrain the conventional head gaskets shaded solid between the cylinder 21 and head 22. Transfer passages 23 are just behind the sectioning plane and are not cut by it. Intake ports are hidden behind the connecting rod in this view. Optional fuel injector 31 is behind, and represented by, the small port in the cylinder beneath the nozzle of the injector. The rest of the injector 31 is hidden. Lower transfer ports 36 are seen as drilled holes cutting the walls of cylinder 21 in the back (intake) side of the gas generator.

In FIG. 8, pistons 37 are attached to the tubular connecting rod 38 by mounting plates 39. Together, these parts comprise the rigid piston assembly 37-38-39. The pistons 37 are by themselves similar to conventional practice in automotive and aircraft piston engines and can be fabricated by modifying standard parts. The piston assembly 37-38-39 is shown at the extreme of the stroke to the left with zero clearance from the cylinder head 22. This is to check that there is no mechanical interference at any position in the variable stroke that is allowed by the free-piston geometry. In practice, the stroke while running will never be as large as that shown here.

The divider element 43 shown in FIG. 8 is a key part of the invention. It divides the volume beneath the pistons into two independent chambers, and provides a mount for bushings 42 through which tubular connecting rod 38 slides. Divider element 43 is sealed by two elastomer O-rings 44 (solidly shaded, sectioned circles), which, in conjunction with the radial clearance between the divider element 43 and case 20, allow the divider element to float radially while being axially fixed. This freedom prevents any binding between the bushings 42 and connecting rod 38 and simplifies both manufacture and assembly of the free-piston gas generator. Hole 45 in case 20 is the inlet for lubricant that flows through a passage drilled radially in element 43 to the space between the inner ends of the bushings 42. When hole 46 in tubular connecting rod 38 passes the lubricant-filled space between bushings 42, lubricant is metered into the tubular connecting rod 38. This lubricant migrates to the space under the head of pistons 37 and lubricates the piston rings from the inside of the piston 37 through oil slots (not shown) in the piston beneath the piston rings (not shown) as is standard procedure in air-cooled piston engines. Any excess lubricant gathers at the lowest point in the center of case 20 and may be removed and reused in a dry-sump configuration.

The upper transfer ports 47 in FIG. 8 are drilled through case 20 and cylinder 21. The passages in the ports 47 are oriented perpendicularly to the axis of the exhaust ports so that the flow from the two sets of ports converges in the cylinder on the side away from the exhaust ports. This convergence directs the incoming intake air upward toward the cylinder head 22 rather than out the exhaust ports. In the preferred embodiment, exhaust port 24, which is shown in FIG. 4 but not visible in this section, opens slightly before the upper transfer port 47, although this timing is subject to further research and is not part of the claims.

Also in FIG. 8, two permanent ring magnets 48 are inserted into connecting rod 38 and are symmetrically arranged about the center of the piston assembly 37-38-39. The ring magnets have holes in the center to pass the lubricant fed through port 46. They are separated by a light sleeve 49 which incorporates a hole aligned with port 46. The sleeve 49 and magnets 48 are held in place with light sleeves 50. Pickup coils 51 are symmetrically arranged on either side of divider element 43. The changing magnetic field generated by the motion of magnets 48 induces a current pulse in coils 51 for each stroke. From the induced pulses, an engine control unit (ECU—not shown) determines both frequency and phase of the harmonic motion and synthesizes a phase-locked digital oscillator matched to the (changing) harmonic motion of the piston assembly. From this digital oscillator, the ECU calculates the precise time for fuel injection and provides other dynamic operating parameters to various vehicle systems and instruments.

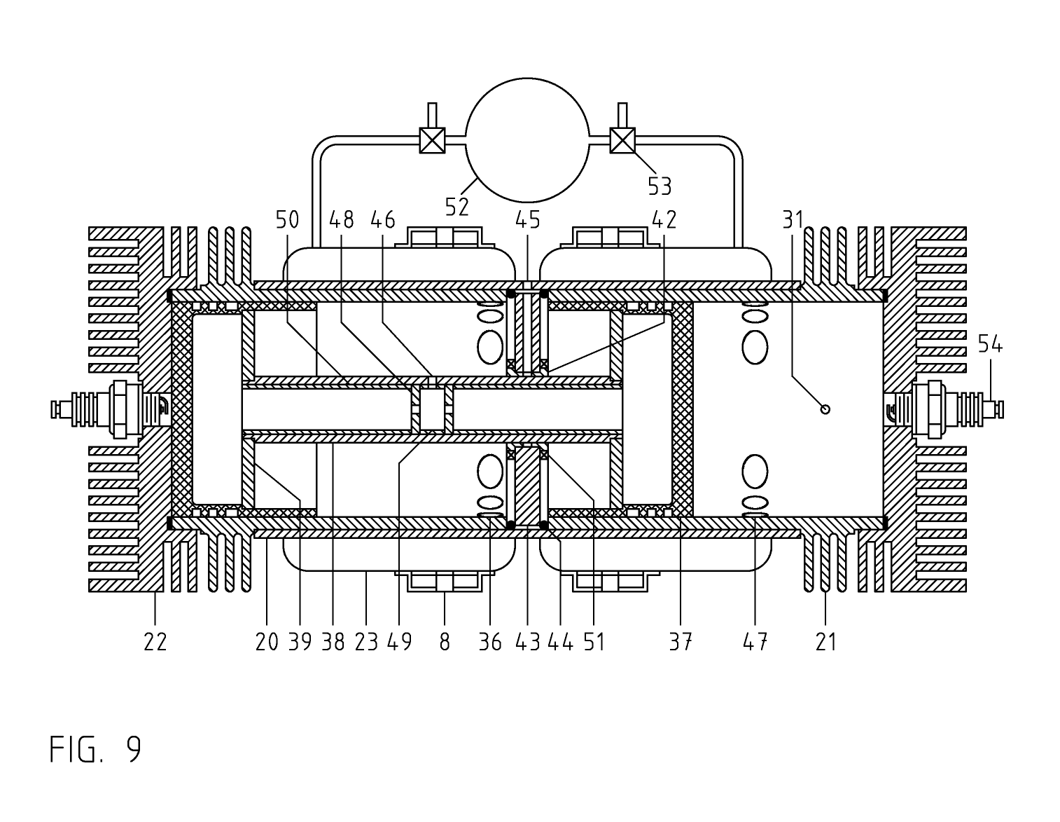

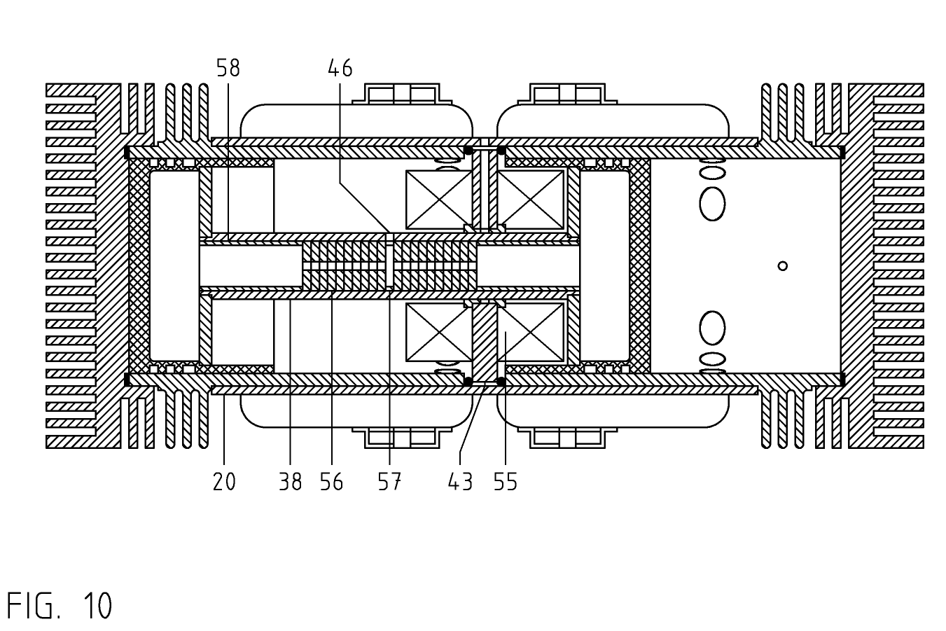

FIG. 9 contains all the elements referenced in FIG. 8 and goes beyond that figure to indicate the elements of an optional compressed-air starting system for the engine. The starting process is as follows: 1) At rest, the piston assembly 37-38-39 will be assumed to be centered, as this is the position where the pressure in all chambers and transfer passages is equalized at ambient levels. In this position, upper transfer ports 47 in both combustion chambers will be covered by pistons 37. 2) Compressed air from reservoir 52 is introduced through one of the three-way valves 53 (for instance, the right valve) into the chamber formed between the underside of the piston 37 and the divider element 43 (for this discussion, the right-hand under-piston chamber). This drives the piston assembly 37-38-39 toward right-hand cylinder head 22 (implied by symmetry). 3) Once the head of right piston 37 has closed off right-side exhaust ports 24 (not shown), fuel is injected into the right-side combustion chamber through fuel injector 31. 4) When pressure in the right-side combustion chamber equals that fed into the right-side under-piston chamber from compressed-air reservoir 52, the piston has reached the furthest extent of its travel toward the right cylinder head 22 (analogous to “top dead center”), and a spark is introduced through spark plug 54, driven by a standard electronic ignition system. 5) Assuming conditions are conducive to combustion, the charge ignites, and the piston assembly 37-38-39 is driven to the left. At the same instant, the right-side three-way valve 53 is opened to the atmosphere to relieve pressure in the right under-piston chamber. This facilitates the motion of piston assembly 37-38-39 and prevents an overpressure situation in the right-side under-piston chamber. 6) The piston assembly 37-38-39 moves to its furthest extent on the left, and the left-side combustion chamber fires, via either spark or autoignition. 7) Once the left-side combustion chamber fires, both three-way valves are closed, the spark-ignition system is deactivated, and the engine commences normal HCCI operation.

Note that the compressed-air starting system of FIG. 9 does not rely on the engine to fire on the first stroke. Instead, by means of filling one under-piston chamber, then evacuating that chamber at top dead center and simultaneously filling the opposite under-piston chamber, the engine may be “cranked” back and forth until ignition is achieved. Note as well that while a conventional electronic ignition system is provided for, it is possible that the compressed-air starting system as described above will achieve compression sufficient for HCCI operation without the need for an initiating spark. This desired behavior can be forwarded by rapidly opening and closing the three-way valves 53 to oscillate the piston assembly 37-38-39 at a high frequency. At the requisite oscillation speed, the resonance frequency of the spring-mass system composed of the compressed air in the opposed combustion chambers and the piston assembly 37-38-39 will be attained: this will maximize the amplitude of mechanical oscillation of the piston assembly and increase the compressing force of the pistons. Finally, note that the optional fuel injection system may be eschewed, and alternative means may be employed to deliver fuel to the combustion chambers, as allowed under the claims. Regardless of which methods are chosen, magnets 48 and pickup coils 51 are used to generate signals which the ECU may use to control the timing of valve operation, fuel injection, and spark, where required, as in FIG. 8.

FIG. 10 presents a simplified view of most of the elements referenced in FIG. 8 but adds an alternative to the compressed air starting system of FIG. 9. In this alternative embodiment, an integral linear electric motor is used for starting the free-piston gas generator and synchronizing multiple gas generators in a multi-gas generator engine, as is possible under the scope of the claims. Fixed electromagnet coils 55 are attached to the divider element 43. Wires for the coils 55 pass through the divider element 43 and case 20 to a controlled electrical power source. The linear motor uses a series of permanent ring magnets 56 centered in the tubular connecting rod 38 and separated by a light sleeve 57. The ring magnets 56 are held in place by sleeves 58. The coils 55 produce a linear magnetic field in the space outlined by their cores that is much like the field produced by a bar magnet having N and S poles, but that can be controlled to switch the orientation of the field (location of the poles). By choosing proper polarity for the electromagnetic field, the permanent magnet can be centered in the coils. Then by switching polarity, the permanent magnet (and thereby the piston assembly) is driven away from the center, compressing the air/fuel charge to be combusted. The inventors have found in practice that momentum will carry the piston assembly through the stable center position to the unstable repulsion position, thus allowing the piston assembly to be oscillated back and forth. Choosing the proper frequency for the phase-locked oscillator driving the coils can take advantage of the resonance frequency of the spring-mass system composed of the compressed air in the cylinder and the piston assembly, thereby achieving a large-amplitude mechanical oscillation of the piston assembly for starting. While a standard spark ignition system may again be required to provide initial combustion, it is anticipated that the above-described resonant oscillation may provide sufficient compression to initiate HCCI operation without the aid of a precipitating spark. The optional spark ignition system is therefore not shown in this figure.

As stated above, the linear electric motor depicted in FIG. 9 can also be used to synchronize multiple free piston assemblies in the event that multiple free-piston units are used in the compound engine. To accomplish this, the coil/magnet configuration functions both as a linear motor and as a linear generator (alternator), depending on synchronization requirements. Functioning as a motor, the coil/magnet configuration accelerates the motion of the free piston assembly and increases oscillating frequency. Functioning as a linear generator (alternator), the coil/magnet configuration produces the opposite effect: piston motion is retarded, and oscillating frequency is reduced. The engine control unit (ECU—not shown) is configured to control the current in multiple coil/magnet configurations in multiple free-piston units, such that the motion of each piston assembly offsets that of the other(s). This minimizes vibration of the compound engine and evens out exhaust pulses so as to improve the efficiency and durability of the power turbine/air motor.

In conclusion, the combination of a double-acting, two-stroke free-piston engine with a power turbine to provide rotating shaft output is not in itself new. What is new is the incorporation of the HCCI combustion model into this compound engine type. Additional novel elements include: 1) the division of the single cylinder case into two functionally separate chambers by the use of an axially fixed, radially floating divider element; 2) the optional incorporation of non-critically-timed fuel injection into the cylinder after the exhaust port closes; 3) the use of a closed-circuit lubrication system in the free-piston portion of the engine; 4) optional inclusion of an integral electrical linear motor for starting and the possible synchronization of multiple free-piston units coupled to a single output shaft; and 5) the use of a positive-displacement air motor as one way of utilizing the high-pressure exhaust output of the free-piston gas generator. Note that the use of a precompressor, as well as the substitution of a positive-displacement air motor for an axial or centrifugal power turbine, are all optional under the claims of the present invention. A precompressor increases the power density of the engine, but is not required. Similarly, for some applications, the positive-displacement air motor option for power extraction makes better use of the level of mass air flow inherent in the free-piston engine, but this may not be true in all applications. In instances 2, 4, and 5, the devices themselves use the prior art, but their optional inclusion in the double-acting, two-stroke HCCI compound free-piston rotating-shaft engine of the present invention is new.

1. A compound, two-stroke internal-combustion engine that delivers superior fuel economy and reduces emissions vs. existing internal combustion engines, comprising:
a) a free-piston component to produce energetic exhaust gas;
b) a rotary device to convert the energy in said energetic exhaust gas to power at a rotating output shaft; and
c) means whereby homogeneous charge compression ignition (HCCI) is utilized as the combustion mode of said free-piston component, thereby achieving superior fuel economy and reduced emissions vs. existing internal combustion engines.

2. The device of claim 1 wherein said rotary device is selected from the group consisting of:
a) a positive displacement air motor;
b) an axial turbine;
c) a centrifugal turbine; and
d) an impulse turbine.

3. The device of claim 1 further comprising a rotary precompressor to deliver intake air to said free-piston component, said rotary precompressor driven either by said rotating output shaft or by a portion of said energetic exhaust gas.

4. The free-piston component of the device of claim 1 further comprising at least one free-piston gas generator assembly, comprising:
a) a single cylinder;
b) intake and exhaust ports located in said cylinder; and
c) two cylinder heads closing the ends of said cylinder.

5. The free-piston gas generator assembly of claim 4 further comprising a double-ended, oscillating piston assembly slidably displaceable in said cylinder, wherein said double-ended, oscillating piston assembly comprises two pistons fixedly attached to each other via a rigid connecting rod.

6. The free-piston gas generator assembly of claim 5 further comprising means by which closed-cylinder fuel injection is used to produce a homogeneous charge of fuel and air well before achieving peak compression.

7. The free-piston gas generator assembly of claim 5 further comprising an axially fixed internal divider element inserted into said cylinder, centrally located between said two cylinder heads and surrounding said rigid connecting rod between said two pistons, thereby separating the regions between said pistons into two independent volumes for intake and charge-transfer functions.

8. The free-piston gas generator assembly of claim 7 wherein said axially fixed internal divider element is configured so that it can float over a limited distance transverse to the axis of said rigid connecting rod to allow easier mechanical tolerance on the alignment of said pistons and said cylinder.

9. The free-piston gas generator assembly of claim 7 further comprising a multiplicity of upper and lower transfer ports in said cylinder to accomplish charge transfer and exhaust scavenging, wherein said transfer ports are arranged perpendicularly to a radius of said cylinder centered on said exhaust ports.

10. The free-piston gas generator assembly of claim 7 further comprising a radial channel in said axially fixed internal divider element, wherein said radial channel is used to introduce lubricating substance into a split bushing in the center of said axially fixed internal divider element and thence though a port in said rigid connecting rod, by means of which arrangement said lubricating substance is distributed internally to said pistons.

11. The free-piston gas generator assembly of claim 7 further comprising means whereby compressed air is used to impart an oscillating movement to said double-ended, oscillating piston assembly to facilitate starting.

12. The free-piston gas generator assembly of claim 7 further comprising means whereby an integral linear electric motor/generator is used to impart an oscillating movement to said double-ended, oscillating piston assembly to facilitate starting.

13. The free-piston gas generator assembly of claim 7 further comprising means whereby an integral linear electric motor/generator is used to regularize the motion of said double-ended, oscillating piston assembly and to synchronize the motion of a multiplicity of said double-ended, oscillating piston assemblies in the event that said compound, two-stroke internal-combustion engine comprises more than one of said free-piston gas generator assemblies.

14. The free-piston gas generator assembly of claim 7 further comprising means by which conventional spark-ignition is used to initiate combustion during engine startup until operation utilizing homogeneous charge compression ignition is established.

15. The free-piston gas generator assembly of claim 7 further comprising electronic means for sensing the position of said pistons.

16. The free-piston gas generator assembly of claim 15 wherein said electronic means for sensing the position of said pistons provides data to be used to determine the timing of closed-cylinder fuel injection.

17. The free-piston gas generator assembly of claim 15 wherein said electronic means for sensing the position of said pistons provides data to be used to determine the timing of an igniting spark used during engine startup.
